(19) United States
(12) Patent Application Publication
(10) Pub. No.: US 2006/0148503 A1
(43) Pub. Date: Jul. 6, 2006

(54) Method and apparatus for setting up a dispatch/push-to-talk call

(76) Inventors: Tajudeen K. Lasisi, Bolingbrook, IL (US); Wen Huang, Westmont, IL (US); Mohammed M. Rahman, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/285,043

(22) Filed: Nov. 21, 2005

Related U.S. Application Data
(60) Provisional application No. 60/640,526, filed on Dec. 31, 2004.

(51) Int. Cl. H04B 7/00

(52) U.S. Cl. 455/518; 455/90.2

(57) ABSTRACT

When a user of a subscriber unit (SU) originates a dispatch, or Push-to-Talk (PTT), non-local call with a target SU, a communication system serving the originating SU notifies the originating SU that the call is a non-local call before establishing the call. By notifying the originating SU as to whether the call is a non-local call, a user of the originating SU may make an informed decision as to whether to incur costs associated with a non-local dispatch or PTT call before completing the call.

### CROSS REFERENCE TO RELATED APPLICATION

The present application claims priority from provisional application Ser. No. 60/640,526, entitled “METHOD AND APPARATUS FOR SETTING UP A DISPATCH/PUSH-TO-TALK CALL,” filed Dec. 31, 2004, which is commonly owned and incorporated herein by reference in its entirety.

### FIELD OF THE INVENTION

The present invention relates generally to wireless communication systems, and, in particular, to a setting up of a dispatch or Push-to-Talk call in a wireless communication system.

### BACKGROUND OF THE INVENTION

When a user of a wireless dispatch subscriber unit, such as a radiotelephone, initiates a dispatch, or Push-to-Talk (PTT), call (herein collectively referred to as a dispatch call) with a target wireless dispatch subscriber unit, such as another radiotelephone, the user dials or inputs a dispatch telephone number that is uniquely associated with the target radiotelephone. For example, a user of the originating radiotelephone may select the dispatch telephone number associated with the target radiotelephone and then initiate the dispatch call by depressing a Push-to-Talk (PTT) key of the user's radiotelephone. In response to the depression of the PTT key, a dispatch network then sets up the call in accordance with well-known techniques and the user does not hear back until the call is set up, at which point the user is provided a Talk Permit Tone (TPT) that informs the user that he or she may begin speaking.

Similar to conventional telephone numbers, the dispatch telephone number provided by the user typically is independent of a current location of the target radiotelephone. As a result, the user may not be aware of a current location of the target radiotelephone at the time that the user initiates the call, which target radiotelephone may have roamed to a network other than the target radiotelephone's home network. However, unlike conventional cellular telephone calls, the user may be billed for the dispatch call on a basis of the current location of the target radiotelephone, as opposed to conventional cellular telephone calls where typically the user is billed for a call based on an area code of the number dialed. That is, when the originating radiotelephone and the target radiotelephone share a same home network and are each currently residing in a coverage area serviced by the home network, then the user may be billed for a local dispatch call. However, when the originating radiotelephone and the target radiotelephone share a same home network and the target radiotelephone has roamed to a coverage area serviced by a visited network, then the user may be billed for a long distance dispatch call.

As a result, a user of a radiotelephone may be surprised to learn subsequent to a completion of a dispatch call, for example, upon receipt of a monthly billing statement, that one or more dispatch calls that the user thought were local calls are instead billed as long distance calls. Such unexpected long distance charges may result in disgruntled users, customer complaints and customer dissatisfaction, and operator dissatisfaction.

Therefore a need exists for a method and an apparatus that alerts a user of a wireless dispatch subscriber unit to a location of a target wireless dispatch subscriber unit prior to an establishment of a dispatch call with the target wireless dispatch subscriber unit.

### BRIEF DESCRIPTION OF THE DRAWINGS

FIG. 1 is a block diagram of a wireless communication system in accordance with an embodiment of the present invention.

FIG. 2 is a block diagram of a subscriber unit of FIG. 1 in accordance with an embodiment of the present invention.

FIG. 3 is a block flow diagram of a dispatch controller of FIG. 1 in accordance with an embodiment of the present invention.

FIG. 4 is a signal flow diagram that illustrates a set up of a dispatch call by the communication system of FIG. 1 in accordance with various embodiments of the present invention.

### DETAILED DESCRIPTION OF THE INVENTION

To address the need for a method and an apparatus that minimizes a retransmission of frames that include padding, a communication system is provided that, when a user of a subscriber unit (SU) originates a dispatch, or Push-to-Talk (PTT), non-local call with a target SU, notifies the originating SU that the call is a non-local call before establishing the call. By notifying the originating SU as to whether the call is a non-local call, a user of the originating SU may make an informed decision as to whether to incur costs associated with a non-local dispatch or PTT call before completing the call.

Generally, an embodiment of the present invention encompasses a method for setting up a dispatch call. The method includes receiving a request to set up a dispatch call from an originating subscriber unit, in response to receiving the request, determining whether the call is a non-local call, and in response to determining that the call is a non-local call, notifying the originating subscriber unit that the call is a non-local call.

Another embodiment of the present invention encompasses a dispatch controller comprising a processor that is configured to receive a request to set up a dispatch call from an originating subscriber unit, in response to receiving the request, determine whether the call is a non-local call, and in response to determining that the call is a non-local call, notify the originating subscriber unit that the call is a non-local call.

Yet another embodiment of the present invention encompasses a subscriber unit comprising a processor that is configured to convey a request to set up a dispatch call from an originating subscriber unit, in response to conveying the request, receive a notification that the call is a non-local call, and in response to receiving the notification, alert a user that the call is a non-local call.

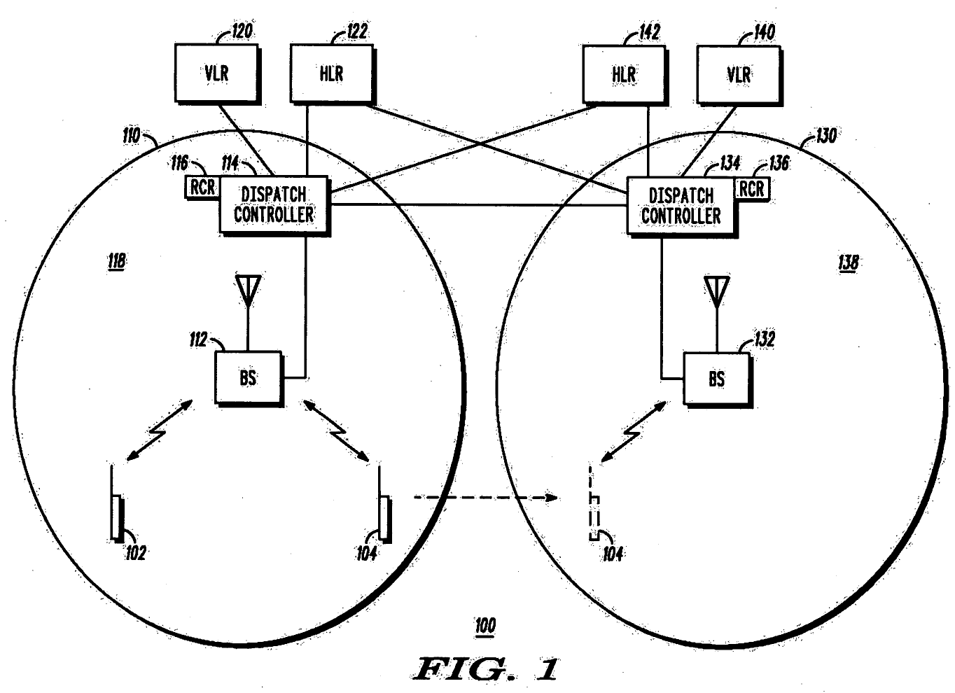

The present invention may be more fully described with reference to FIGS. 1-4. FIG. 1 is a block diagram of a wireless communication system 100 in accordance with an embodiment of the present invention. Communication system 100 comprises multiple communication networks 110, 130. Each communication network 110, 130 comprises a respective at least one base station (BS) 112, 132, preferably an “iDEN” Enhanced Base Transceiver Station (EBTS) that is commercially available from Motorola, Inc. of Schaumburg, Ill. Each communication network 110, 130 provides communication services to wireless subscriber units (SUs) residing in a corresponding coverage area 118, 138 serviced by the network via a respective at least one BS 112, 132.

Each communication network 110, 130 further comprises a respective at least one dispatch controller 114, 134, preferably a “MOTOROLA” Dispatch Application Processor (DAP) that is commercially available from Motorola, Inc. of Schaumburg, Ill., that is coupled to the at least one BS 112, 132 associated with the network. Each dispatch controller 114, 134 includes or is coupled to a respective subscriber unit database (SU database) 116, 136, preferably a Recent Call Record (RCR), that maintains call records that comprise a location, such as a serving BS, a serving dispatch controller, and/or a serving network, of SUs that made a call in a coverage area serviced by the dispatch controller, and which location is based on a last such call made by the SU. In addition, the SU database 116, 136 respectively associated with dispatch controllers 114, 134 may further maintain an SU identifier and dispatch call-related information, such as a dispatch telephone number, in association with the SU.

Communication system 100 further comprises multiple dispatch-enabled wireless subscriber units (SUs) 102, 104 (two shown), such as but not limited to a mobile radio, a portable radio, a radiotelephone, a Push-to-Talk over cellular (PoC)-enabled cellular telephone, or a wireless-enabled personal computer (PC), laptop computer, or personal digital assistant (PDA) with Push-to-Talk capabilities. For the purposes of illustrating the principles of the present invention, each SU of the multiple SUs 102, 104 subscribes to the services of a same network 110, which network is referred to herein as a home network of the subscriber unit.

Communication system 100 further comprises multiple Visited Location Registers (VLRs) 120, 140 and multiple Home Location Registers (HLRs). Each of VLR 120 and HLR 122 provides location and provisioning services to network 110, and more particularly to dispatch controller 114, and each of VLR 140 and HLR 142 provides location and provisioning services to network 130, and more particularly to dispatch controller 134. In addition, each dispatch controller 114, 134 may further communicate with all other HLRs in communication system 100. That is, each of dispatch controllers 114 and 134 may communicate with both HLR 122 and HLR 142. As is known in the art, each VLR 120, 140 maintains a profile of each SU that is currently operating in, that is, registered in, a respectively associated network 110, 130, even though the SU may be subscribed to the services of a different network. Also as is known in the art, each HLR 122, 142 maintains a profile of each SU that is subscribed to the services of a respectively associated network 110, 130, even though the SU may be operating in, that is, currently registered in, a different network. Each profile of an SU maintained by a VLR 120, 140 or an HLR 122, 142 includes an SU identifier associated with the SU, a listing of services subscribed to by the SU, and a latest known location of the SU, such as a BS, a dispatch controller, or a network that is last known to have serviced the SU.

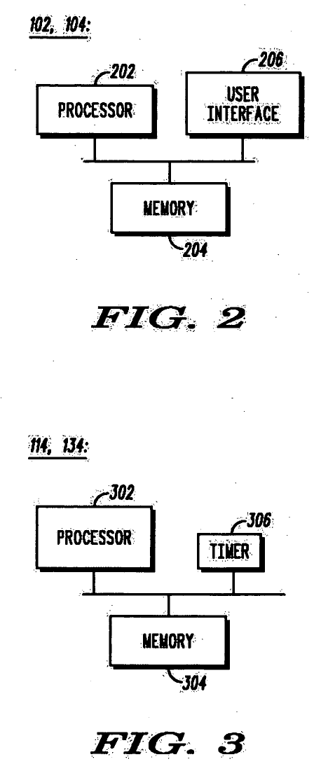

FIG. 2 is a block diagram of SUs 102 and 104 in accordance with an embodiment of the present invention. Each SU 102, 104 includes a user interface 206 coupled to a processor 202, such as one or more microprocessors, microcontrollers, digital signal processors (DSPs), combinations thereof or such other devices known to those having ordinary skill in the art. Each SU 102, 104 further includes at least one memory device 204 associated with the corresponding processor, such as random access memory (RAM), dynamic random access memory (DRAM), and/or read only memory (ROM) or equivalents thereof, that store data and programs that may be executed by the processor. The at least one memory device 204 of each SU 102, 104 further maintains an SU identifier and dispatch call-related information, for example, a dispatch telephone number, associated with the SU. In addition, the at least one memory device 204 of each SU 102, 104 maintains an SU identifier and/or dispatch call-related information, for example, a dispatch telephone number, associated with each of one or more other SUs that subscribe to the services of communication system 100. Each of the SU identifiers and dispatch call-related information maintained in the at least one memory device 204 of each SU 102, 104 may be preprogrammed into the at least one memory device or may be added to the at least one memory device by a user of the SU.

User interface 206 provides a user of the SU with the capability of interacting with the SU, including inputting instructions into the SU. In one embodiment of the present invention, user interface 206 includes a display screen and a keypad that includes multiple keys, including a Push-to-Talk (PTT) key. In another embodiment of the present invention, user interface 206 includes a display screen that comprises a touch screen that is able to determine a position (i.e., an X-coordinate and a Y-coordinate) of a user's touch on the touch screen and convey the position data to processor 202. Based on the position data, processor 202 then translates the user's touch into an instruction. Preferably, the display screen may display a “keypad” screen that comprises multiple softkeys such softkeys corresponding to keys on a conventional telephone keypad and further including a PTT softkey.

FIG. 3 is a block diagram of dispatch controllers 114, 134 in accordance with an embodiment of the present invention. Each dispatch controller 114, 134 includes a processor 302, such as one or more microprocessors, microcontrollers, digital signal processors (DSPs), combinations thereof or such other devices known to those having ordinary skill in the art. Each dispatch controller 114, 134 further includes at least one memory device 304 associated with the corresponding processor, such as random access memory (RAM), dynamic random access memory (DRAM), and/or read only memory (ROM) or equivalents thereof, that store data and programs that may be executed by the processor. The at least one memory device 304 of each dispatch controller 114, 134 further maintains a dispatch controller identifier that is associated with, and that identifies, the dispatch controller.

The embodiments of the present invention preferably are implemented within SUs 102 and 104 and dispatch controllers 114 and 134, and more particularly with or in software programs and instructions stored in the respective at least one memory devices 204 and 304, and respectively executed by processors 202 and 302, of the SUs and dispatch controllers. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the SUs 102, 104 and dispatch controllers 114, 134. Based on the present disclosure, one skilled in the art will be readily capable of producing and implementing such software and/or hardware without undo experimentation.

Preferably, communication system 100 is an “iDEN” communication system that operates in accordance with the iDEN protocols. However, those who are of ordinary skill in the art realize that communication system 100 may operate in accordance with any wireless telecommunication system that provides dispatch-type communication services, such as but not limited to a dispatch-enabled, or Push-to-Talk over cellular (PoC)-enabled, Time Division Multiple Access (TDMA) communication system, Code Division Multiple Access (CDMA) communication system, Global System for Mobile Communications (GSM) communication system, Frequency Division Multiple Access (FDMA) communication system, or Orthogonal Frequency Division Multiple Access (OFDM) communication system.

When an SU, such as SUs 102 and 104, activates in a network or is handed off to a network, such as either of networks 110 and 130, the SU registers with a dispatch controller serving a coverage area in which the SU resides via a BS serving the coverage area. As part of the registration process, the SU conveys its SU identifier to the serving BS. The serving BS then forwards the SU identifier to the dispatch controller serving the BS. The serving BS further forwards a BS identifier associated with the BS to the serving dispatch controller.

In response to receiving the SU and BS identifiers, the serving dispatch controller updates a routing list maintained in an SU database associated with the dispatch controller. The routing list is updated to reflect the SU's present location, for example, by adding the SU identifier in association with BS identifier to a list of SUs serviced by the dispatch controller. The serving dispatch controller further notifies a location and provisioning database associated with a home network of the SU of a present location of the SU. That is, the serving dispatch controller conveys, to the home network location and provisioning database, the received SU identifier and a dispatch controller identifier associated with the serving dispatch controller. The serving dispatch controller may further convey, to the home network location and provisioning database, the BS identifier associated with the serving BS.

For example, suppose an SU, such as SU 102 (or SU 104), is subscribed to the services of network 110, that is, network 110 is the home network of the SU. Since network 110 is the home network of SU 102, HLR 122 is responsible for maintaining and tracking provisioning and mobility information with respect to the SU. When SU 102 registers with its home network, that is, in network 110 and with dispatch controller 114, via a serving BS, such as BS 112, dispatch controller 114 arranges for an updating of a location of the SU in the HLR associated with the dispatch controller, that is, HLR 122, and the VLR associated with the dispatch controller, that is, VLR 120. Each of HLR 122 and VLR 120 stores the current location of the SU, such as one or more of a BS 112, dispatch controller 114, and network 110 currently serving the SU, in association with the SU, such as in association with the SU identifier corresponding to SU 102. It may be noted that SU 102 may register with network 10 and dispatch controller 114 as a result of activating in network 110 or as a result of a handoff of the SU from another network, such as network 130, to network 110.

By way of another example, suppose SU 102 (or SU 104) is subscribed to the services of network 110, that is, network 110, but registers in network 130, that is, with dispatch controller 134. Again, SU 102 may register with network 130 and dispatch controller 134 as a result of activating in network 130 or as a result of a handoff of the SU from another network, such as network 110, to network 130. When SU 102 registers with dispatch controller 134 via a serving BS, such as BS 132, dispatch controller 134 arranges for an updating of a location of the SU in both the VLR associated with the dispatch controller where the SU is registering, that is dispatch controller 134 and VLR 140, and the HLR of the SU's home network, that is, HLR 122. Again, each of VLR 140 and HLR 122 may store the current location of the SU, such as one or more of a BS 112, dispatch controller 114, and network 110 currently serving the SU, in association with in association with the SU, such as in association with the SU identifier corresponding to SU 102.

In communication system 100, when an SU originates a dispatch, or Push-to-Talk (PTT), non-local call with a target SU, the communication system may notify the originating SU as to whether the call is a non-local call before establishing the call. By notifying the originating SU as to whether the call is a non-local call, a user of the originating SU may make an informed decision as to whether to incur costs associated with a non-local call before completing the call.

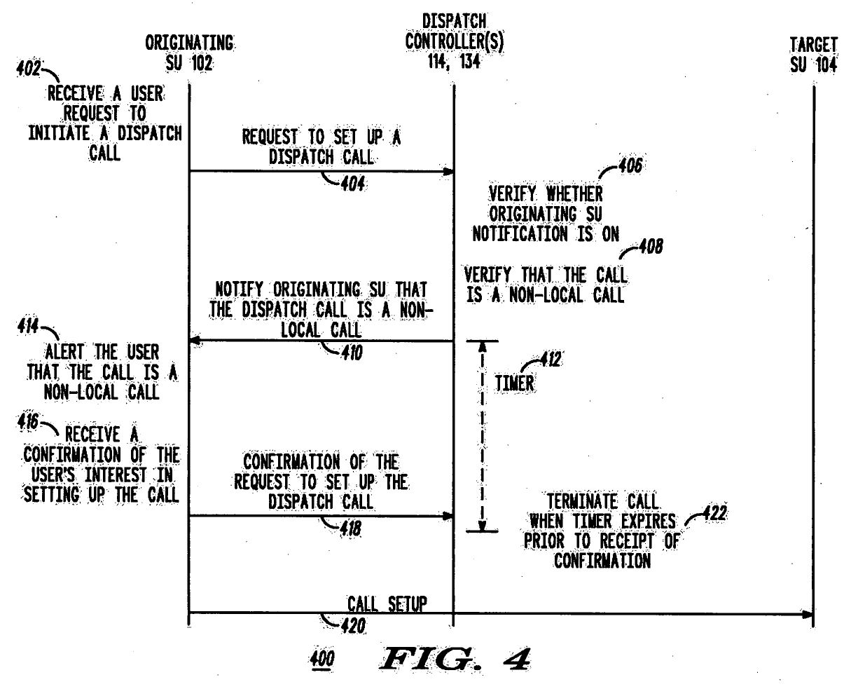

Referring now to FIG. 4, a signal flow diagram 400 is provided that illustrates a set up of a dispatch call by communication system 100 in accordance with various embodiments of the present invention. Signal flow diagram 400 begins when a user of a first SU, such as SU 102, communicates (402), to the SU, a first request to set up a dispatch or PTT call (herein collectively referred to as a dispatch call) with a second, target SU, such as SU 104. For example, the user may input a dispatch telephone number associated with the target SU via user interface 206 of the SU or may select an identifier associated with target SU 104 from a menu in the user interface, such as a dispatch or PTT telephone number (herein collectively referred to as a dispatch telephone number) associated with the target SU, and, in association with the input or selection, depress a PTT key in the user interface or touch a corresponding PTT softkey. In response to receiving the selection and the first request, originating SU 102 conveys (404) a request to setup a dispatch call, preferably a first call setup request as is known in the art, to a dispatch controller serving the SU, that is, dispatch controller 114, via a BS serving the SU, that is, BS 112. The first call setup request includes the SU identifier associated with the originating SU and further includes the dispatch telephone number associated with the target SU.

In response to receiving the request to setup a dispatch call, dispatch controller 114 determines (408) whether the dispatch call is a non-local call. Although the functions of FIG. 4 are described with respect to a dispatch controller serving an originating SU, that is, dispatch controller 114 and SU 102, one of ordinary skill in the art realizes that the functions performed by dispatch controller 114 may be distributed among the dispatch controller 114 and a dispatch controller serving a target SU, that is, dispatch controller 134 that serves SU 104.

A local call comprises a call to a target SU that does not result in an additional charge for a non-local call. What constitutes a local call, as opposed to a non-local call, is up to an operator of the network serving the originating SU, that is, network 110. For example, a local call may comprise a call to a target SU that serviced by a same dispatch controller, that is, dispatch controller 114, as originating SU 102. By way of another example, a local dispatch call may comprise a call to a target SU that in a same network as originating SU 102, as opposed to being serviced by a same dispatch controller as SU 102. In order to determine whether a call is a local call or a non-local call, dispatch controller 114 needs to determine a location of the target SU, that is, SU 104. Typically, dispatch controller 114 determines a location of the target SU by reference to one or more of databases 116, 120, 122, and 142. One of ordinary skill in the art realizes that many algorithms exist for determining a location of an SU by reference to one or more of such databases, and that any such algorithm may be used herein without departing from the spirit and scope of the present invention.

For example, in one embodiment of the present invention, suppose a home network of target SU 104 is network 130. Dispatch controller 114 may determine a location of SU 104 by first querying the VLR 120 for a location of the SU. If VLR 120 informs dispatch controller 114 that the SU is currently registered in the coverage area, that is, coverage area 118, or the network, that is, network 110, associated with dispatch controller 114, whichever is appropriate for a local call, then dispatch controller 114 may conclude that the call is a local call. If SU 104 is not currently registered with VLR 120, then dispatch controller may query SU database 116 for a location of the SU. In one such embodiment of the present invention, if SU database 116 indicates that the SU is located in the coverage area 118 or the network 110 associated with dispatch controller 114, whichever is appropriate, then dispatch controller 114 may conclude that the call is a local call. When SU 104 is not registered with either VLR 120 or SU database 116, dispatch controller 114 may conclude that the call is a non-local call. However, in another such embodiment of the present invention, when SU 104 is not registered with either VLR 120 or SU database 116, dispatch controller 114 may further query an HLR associated with a home network of the SU, that is, HLR 142, to confirm a location of the SU. When HLR 142 informs that the SU 104 is currently registered outside of the coverage area 118 or network 110 associated with dispatch controller 114, whichever is appropriate, then dispatch controller 114 may conclude that the call is a non-local call.

In another embodiment of the present invention, if SU 104 is not registered with VLR 120 but SU database 116 indicates that the SU is in the coverage area 138 or network 130 associated with dispatch controller 134, the dispatch controller may still query the HLR associated with SU 104's home network, that is, HLR 142, to confirm a current location of the SU. If HLR 142 confirms that SU 104 is currently registered in the coverage area 138 or network 130 associated with dispatch controller 134, whichever is appropriate, then dispatch controller 114 may conclude that the call is a non-local call. If SU database 116 indicates that SU 104 is in coverage area 118 or network 110 associated with dispatch controller 114, then dispatch controller 114 may conclude that the call is a local call and setup the call on the current system.

In yet another embodiment of the present invention, suppose a home network of target SU 104 is network 110. Dispatch controller 114 may then determine a location of the SU merely by reference to HLR 122. If HLR 122 confirms that SU 104 is currently registered in the coverage area 118 or network 110 associated with dispatch controller 114, whichever is appropriate, then dispatch controller 114 may conclude that the call is a local call. If HLR 122 indicates that SU 104 is no longer registered in the coverage area 118 or network 110 associated with dispatch controller 114, then dispatch controller 114 may conclude that the call is a non-local call. In still other embodiments of the present invention, dispatch controller 114 may query one or more of VLR 120 and SU database 116, as described above or in various orders as may occur to one of ordinary skill in the art, to determine if SU 104 is currently registered or located in the coverage area 118 or network 110 associated with dispatch controller 114, whichever is appropriate. Based on the response from the VLR 120 and/or SU database 116, or further based on a confirming inquiry of, and response from, HLR 122, dispatch controller 114 may determine whether SU 104 is currently registered in the coverage area 118 or network 110 associated with dispatch controller, whichever is appropriate, and based on the determination conclude whether the call is a local call or a non-local call.

When, dispatch controller 114 determines (408) that the dispatch call is a local call, then dispatch controller 114 sets up the dispatch call in accordance with well-known techniques and without announcing to the user that the call is a non-local call. However, when dispatch controller 114 determines (408) that the dispatch call is a non-local call, then dispatch controller 114 notifies (410) originating SU 102 that call is a non-local call. In addition to notifying SU 102, dispatch controller 114 may further start (412) a timer 306 associated with the dispatch controller. Timer 306 counts down a period of time during which dispatch controller 114 awaits a response to the notification from originating SU 102. The period of time counted down by timer 306 is up to a designer of communication system 100 and may include consideration of a time required for round-trip messaging with a serviced SU and typical response times of a user of the serviced SU.

In another embodiment of the present invention, notification of originating SU 102 that call is a non-local call, and the optional starting of timer 306, may be further conditioned on a determination of whether originating SU 102 supports and/or has enabled a non-local call notification function. That is, in such an embodiment, in response to receiving the request to setup a dispatch call, dispatch controller 114 may determine (406) whether originating SU 102 supports and/or has enabled a non-local call notification function. The non-local call notification function comprises a capability of originating SU 102 to notify the user of the SU that a dispatch call is a non-local call. In one such embodiment of the present invention, the first request to setup a dispatch call may include a data field whereby the originating SU indicates whether the SU supports a non-local call notification function, or indicates whether the function is enabled or disabled when the user is capable of enabling/disabling the function. Based on the received first request to setup a dispatch call, dispatch controller 114 may then determine whether originating SU 102 supports, or has activated, the non-local call notification function. In another such embodiment of the present invention, dispatch controller 114 may determine whether originating SU 102 supports the non-local call notification function by reference to a home HLR, such as HLR 122, or a VLR associated with the dispatch controller, that is, VLR 120, which HLR or VLR may comprise, in its profile of SU 102, the capabilities of SU 102, including whether the SU supports a non-local call notification function. In such an embodiment, when dispatch controller 114 determines (406 that originating SU 102 supports and/or has enabled a non-local call notification function and further determines (408) that the dispatch call is a non-local call, then dispatch controller 114 notifies (410) originating SU 102 that call is a non-local call.

In yet another embodiment of the present invention, when determining whether a call is a local call or a non-local call and when a dispatch telephone number includes information that indicates whether the call is a local call or a non-local call, such as an equivalent of area code for a conventional telephone number, then the determination of whether the dispatch call is a local call or a non-local call may further comprise a determination of whether the called dispatch telephone number is local number or a non-local number. A local number comprises a called number that results in a local call. In one such embodiment of the present invention, each dispatch telephone number may include a sequence, akin to an area code of a conventional telephone number, that is uniquely associated with a particular network 110, 130 or dispatch controller 114, 134. Such sequences may be known to the dispatch controller and the dispatch controller may then determine, based on an analysis of the sequence, whether the call is a local call. In another such embodiment of the present invention, dispatch controller 114 may determine whether the dispatch telephone number is a local number by reference to the home HLR, that is, HLR 122, or the VLR associated with the dispatch controller, that is, VLR 120. That is, based on the called number, dispatch controller 114 may retrieve from the HLR or VLR a home network and/or a home dispatch controller associated with the target SU. When the home network is the network serviced by dispatch controller 114, or the home dispatch controller is dispatch controller 114, whichever is appropriate, dispatch controller 114 may determine that the dialed number is a local number.

When dispatch controller 114 determines that the dispatch telephone number is a non-local number, then dispatch controller 114 may set up the dispatch call in accordance with well-known techniques and without alerting the user of origination SU 102 that the call is a non-local call. That is, since the user of originating SU 102 has requested a call to a non-local number, it may be assumed that the user expects to be billed for a non-local call and that there is no need to notify the user that he or she will be so billed. When dispatch controller 114 determines that the dispatch telephone number is a local number but that the call is a non-local call, then the dispatch controller dispatch controller 114 may notify (410) originating SU 102 that call is a non-local and, optionally, may start (412) timer 306.

When originating SU 102 receives (410) the notification that the call is a non-local call, originating SU 102 alerts (414) the user of the SU that the call is a non-local call. For example, in one embodiment of the present invention, the notification may comprise a message that informs that the call is a non-local call and processor 202 of originating SU 102 may display the message included in the notification on a display screen of user interface 206. By way of another example, in another embodiment of the present invention, in response to receiving the notification, processor 202 of originating SU 102 may retrieve a textual message from at least one memory device 206 that informs that the call is a non-local call and display the retrieved message on the display screen. In yet another embodiment of the present invention, processor 202 of originating SU 102 may convey the retrieved textual message to a text-to-speech (TTS) module (not shown) included in the SU that converts the message to speech. The speech may then be played to the user of SU 102 via an audio component of user interface 206. In still other embodiments of the present invention, processor 202 of originating SU 102 may display icons or play audio tones that indicate that call is a non-local call. One of ordinary skill in the art realizes that numerous means may be employed to alert a user of the SU that the call is a non-local call, and the use of any particular means is up to a designer of communication system 100 and is not critical to the present invention.

In response to the alert, the user of originating SU 102 may decide to terminate the call or to continue the call. When the user decides to terminate the call, the user may ignore the alert and do nothing. When the user decides to continue the call, the user confirms (416) his or her interest in continuing the call. For example, the user may again depress the PTT key or touch a PTT softkey. By way of another example, the user may depress a key on a keyboard or touch a softkey, icon, or textual message on a display screen of user interface 206 of SU 102 that corresponds to an instruction to continue the call. In response to receiving the confirmation of the user's interest in continuing the call, originating SU 102 conveys (418), to dispatch controller 114, a confirmation of the request to set up the dispatch call, preferably by conveying a second request to set up the dispatch call, such as a second call setup request.

When the dispatch controller 114 receives (418) the confirmation of the request to set up the dispatch call, or when timer 306 has been started and dispatch controller 114 receives the confirmation prior to an expiration of the timer, then dispatch controller 114 sets up (420) the dispatch call in accordance with well-known techniques. When timer 306 has been started and further expires before dispatch controller 114 receives the confirmation from SU 102, then dispatch controller 114 terminates (422) the call.

By notifying an originating SU that a dispatch, or PTT, call is a non-local call before establishing a non-local call, communication system 100 allows the user to make an informed decision as to whether to incur costs associated with a non-local dispatch or PTT call before completing the call. In determining whether to notify the originating SU that the call is a non-local call, communication system 100 may take into consideration one or more of the dialed dispatch telephone number, the home networks of the originating SU and a target SU, the dispatch controller or network currently serving the target SU, and whether the originating SU supports and/or has enabled a non-local call notification function. By providing the non-local call notification, communication system 100 reduces potential dissatisfaction resulting from a billing of one or more dispatch calls that the user thought were local calls instead as long distance calls.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

What is claimed is:

1. A method for setting up a dispatch call comprising:
receiving a request to set up a dispatch call from an originating subscriber unit;
in response to receiving the request, determining whether the call is a non-local call; and
in response to determining that the call is a non-local call, notifying the originating subscriber unit that the call is a non-local call.

2. The method of claim 1, further comprising:
in response to notifying the originating subscriber unit that the call is a non-local call, receiving a confirmation of interest in setting up the dispatch call; and
in response to receiving the confirmation, setting up the dispatch call.

3. The method of claim 1, further comprising:
in response to determining that the call is a non-local call, starting a timer;
when the timer expires prior to receiving a confirmation of interest in setting up the dispatch call, terminating the call; and
when a confirmation of interest in setting up the dispatch call is received prior to an expiration of the timer, setting up the dispatch call.

4. The method of claim 1, further comprising, in response to receiving the request, determining whether the originating subscriber unit supports a non-local call notification function.

5. The method of claim 1, further comprising, in response to receiving the request, determining whether the originating subscriber unit has enabled a non-local call notification function.

6. The method of claim 1, wherein determining whether the call is a non-local call comprises determining whether the called number is a local number.

7. The method of claim 6, further comprising:
in response to determining that the called number is a non-local number, setting up the call without notifying the originating subscriber unit that the call is a non-local call; and
wherein notifying comprises, in response to determining that the called number is a local number and that the call is a non-local call, notifying the originating subscriber unit that the call is a non-local call.

8. The method of claim 6, further comprising:
receiving, by the originating subscriber unit, the notification that the call is a non-local call; and
in response to receiving the notification, alerting a user that the call is a non-local call.

9. The method of claim 8, further comprising:
in response to alerting a user that the call is a non-local call, receiving a confirmation of the user's interest in continuing the call; and
conveying a confirmation of the user's interest in setting up the call.

10. The method of claim 9, further comprising:
receiving the confirmation of interest in setting up the dispatch call; and
in response to receiving the confirmation, setting up the dispatch call.

11. A dispatch controller comprising a processor that is configured to receive a request to set up a dispatch call from an originating subscriber unit, in response to receiving the request, determine whether the call is a non-local call, and in response to determining that the call is a non-local call, notify the originating subscriber unit that the call is a non-local call.

12. The dispatch controller of claim 11, wherein the processor further is configured to, in response to notifying the originating subscriber unit that the call is a non-local call, receive a confirmation of interest in setting up the dispatch call and in response to receiving the confirmation, set up the dispatch call.

13. The dispatch controller of claim 11, wherein the dispatch controller further comprises a timer and wherein the processor further is configured to, in response to determining that the call is a non-local call, starting the timer, when the timer expires prior to receiving a confirmation of interest in setting up the dispatch call, terminate the call, and when a confirmation of interest in setting up the dispatch call is received prior to an expiration of the timer, set up the dispatch call.

14. The dispatch controller of claim 11, wherein the processor further is configured to, in response to receiving the request, determine whether the originating subscriber unit supports a non-local call notification function.

15. The dispatch controller of claim 11, wherein the processor further is configured to, in response to receiving the request, determine whether the originating subscriber unit has enabled a non-local call notification function.

16. The dispatch controller of claim 11, wherein determining, by the processor, whether the call is a non-local call comprises determining whether the called number is a local number.

17. The dispatch controller of claim 16, wherein the processor further is configured to, in response to determining that the called number is a non-local number, set up the call without notifying the originating subscriber unit that the call is a non-local call and wherein notifying comprises, in response to determining that the called number is a local number and that the call is a non-local call, notifying the originating subscriber unit that the call is a non-local call.

18. A subscriber unit comprising a processor that is configured to convey a request to set up a dispatch call from an originating subscriber unit, in response to conveying the request, receive a notification that the call is a non-local call, and in response to receiving the notification, alert a user that the call is a non-local call.

19. The subscriber unit of claim 18, wherein the processor further is configured to, in response to alerting a user that the call is a non-local call, receive a confirmation of the user's interest in continuing the call and, in response to receiving the confirmation, convey a confirmation of the user's interest in setting up the call.
